(19) United States
(12) Patent Application Publication
(10) Pub. No.: US 2025/0128350 A1
(43) Pub. Date: Apr. 24, 2025

(54) ULTRAFAST LASER PROCESSING METHOD FOR FLEXIBLE DOUBLE-SIDED ELECTRODES

(71) Applicant: Harbin Intitute of Technology, Harbin, Heilongjiang (CN)

(72) Inventors: Ye DING, Harbin, Heilongjiang (CN); Lijun YANG, Harbin, Heilongjiang (CN); Lianfu WANG, Harbin, Heilongjiang (CN)

(21) Appl. No.: 18/685,461

(22) PCT Filed: Dec. 20, 2021
(86) PCT No.: PCT/CN2021/139557

§ 371 Date: Feb. 21, 2024

(30) Foreign Application Priority Data
Nov. 30, 2021 (CN) 202111446811.0

(51) Int. Cl. B23K 26/06; B23K 26/03; B23K 26/08; B23K 26/70; B23K 101/38

(52) U.S. Cl. CPC B23K 26/0648; B23K 26/032; B23K 26/083; B23K 26/70; B23K 2101/38

(57) ABSTRACT

The method includes: fixing a flexible electrode substrate to a working table of an ultrafast laser processing device; switching on an ultrafast laser unit of the ultrafast laser processing device to output an ultrafast laser with processing required output parameters; and adjusting the ultrafast laser to an effective acting position of the flexible electrode substrate, so as to carry out synchronized double-sided processing on the flexible electrode substrate. According to the present disclosure, synchronized double-sided processing is carried out on the flexible electrode substrate by means of the ultrafast laser to synchronously construct electrodes on upper and lower surfaces of the flexible electrode substrate, thereby obtaining flexible double-sided electrodes to be used for the preparation of micro energy storage devices and the like, and achieving high quality, high precision and high efficiency of the processing of the flexible double-sided electrodes.

### CROSS-REFERENCE TO RELATED APPLICATIONS

This Application is a national stage application of PCT/CN2021/139557. This application claims priorities from PCT Application No. PCT/CN2021/139557, filed Dec. 20, 2021, and from the Chinese patent application 202111446811.0 filed Nov. 30, 2021, the content of which are incorporated herein in the entirety by reference.

### TECHNICAL FIELD

The present disclosure relates to the technical field of electrode processing, in particular to an ultrafast laser processing method for flexible double-sided electrodes.

### BACKGROUND ART

Supercapacitors have been widely used as an advanced electrochemical energy storage device, exhibiting higher power density than batteries and higher energy density than conventional capacitors, safely delivering high power and fast charging and discharging, and having an ultra-long cycle life.

However, although the energy density of supercapacitors is higher than that of conventional solid-state electrolytic capacitors, it is still significantly lower than that of batteries and fuel cells. In order to enhance the energy density of supercapacitors, in addition to the improvement of the electrode material, there is a great necessity to improve the electrode macro-microstructure, which is closely related to the energy conversion efficiency, specific capacity, multiplicity performance and other indexes of supercapacitors. However, in the existing technology, chemical synthesis assembly, wet spinning, inkjet printing, etc. are mostly used to construct electrodes of supercapacitors, which have problems such as complicated process, poor repeatability, low processing precision and efficiency.

### SUMMARY

The present disclosure aims to solve the problem of how to improve the efficiency and quality of electrode construction.

In order to solve the above problem, the present disclosures provides an ultrafast laser processing method for flexible double-sided electrodes. The method includes:
fixing a flexible electrode substrate to a working table of an ultrafast laser processing device;
switching on an ultrafast laser unit of the ultrafast laser processing device to output an ultrafast laser with processing required output parameters; and
adjusting the ultrafast laser to an effective acting position of the flexible electrode substrate, so as to carry out synchronized double-sided processing on the flexible electrode substrate.

Optionally, an absolute value of a difference between a thickness of the flexible electrode substrate and twice a Rayleigh length of the ultrafast laser on a focusing region of the flexible electrode substrate is less than a first threshold; and the adjusting the ultrafast laser to an effective acting position of the flexible electrode substrate includes:
adjusting a focal position of the ultrafast laser to a center position between upper and lower surfaces of the flexible electrode substrate.

Optionally, the fixing a flexible electrode substrate to a working table of an ultrafast laser processing device includes:
spraying an electrode material on the upper and lower surfaces of the flexible electrode substrate; and
fixing the flexible electrode substrate sprayed with the electrode material on the working table in a flat and suspended manner.

Optionally, after the adjusting the ultrafast laser to an effective acting position of the flexible electrode substrate, so as to carry out synchronized double-sided processing on the flexible electrode substrate, the ultrafast laser processing method for flexible double-sided electrodes further includes:
processing a through hole in an electrode contact portion of the flexible electrode substrate by means of the ultrafast laser; and
coating the through hole with a conductive material to connect electrodes on the upper and lower surfaces of the flexible electrode substrate.

Optionally, the switching on an ultrafast laser unit of the ultrafast laser processing device to output an ultrafast laser with processing required output parameters includes:
switching on the ultrafast laser unit to output the ultrafast laser at a first preset power; focusing the ultrafast laser to the surfaces of the flexible electrode substrate;
switching off the ultrafast laser unit, and setting output parameters of the ultrafast laser unit as the processing required output parameters; and
switching back on the ultrafast laser unit.

Optionally, the ultrafast laser processing device further includes a laser transmission shaping mechanism, the laser transmission shaping mechanism including an optical shutter, a beam expander, a half-wave plate, a reflector group, and a focusing objective lens; and the ultrafast laser outputted by the ultrafast laser unit acts on the flexible electrode substrate after passing through the optical shutter, the beam expander, the half-wave plate, the reflector group, and the focusing objective lens in sequence.

Optionally, the ultrafast laser processing device further includes a focusing and observing mechanism, the focusing and observing mechanism includes a white light source and an observing mirror group, the white light source is used for emitting a white light that is coaxially incident onto the surfaces of the flexible electrode substrate with the ultrafast laser, and the observing mirror group is used for receiving part of the white light reflected by the flexible electrode substrate.

Optionally, the working table includes a processing table and a fixing fixture disposed on the processing table and adapted to fixing the flexible electrode substrate, and at least one of the processing table and the fixing fixture is adapted to moving relative to the focusing objective lens.

Optionally, the ultrafast laser processing device further includes an air supply mechanism, the air supply mechanism having a nozzle disposed towards the fixing fixture; and after the adjusting the ultrafast laser to an effective acting position of the flexible electrode substrate, so as to carry out synchronized double-sided processing on the flexible electrode substrate, and prior to processing through hole in an electrode contact portion of the flexible electrode substrate by means of the ultrafast laser, the ultrafast laser processing method for flexible double-sided electrodes further includes:
switching on the air supply mechanism.

Optionally, after the switching on the air supply mechanism, and prior to processing through holes in an electrode contact portion of the flexible electrode substrate by means of the ultrafast laser, the ultrafast laser processing method for flexible double-sided electrodes further includes:
controlling the working table to move the flexible electrode substrate according to a given instruction.

Compared with the prior art, the present disclosure has the following beneficial effects: The method carries out synchronized double-sided processing on the flexible electrode substrate by means of the ultrafast laser to synchronously construct electrodes on the upper and lower surfaces of the flexible electrode substrate, thereby obtaining flexible double-sided electrodes to be used for the preparation of micro energy storage devices (for example, micro-supercapacitors), and the like, having the advantages of high quality, high precision, high efficiency, etc. of laser processing, and achieving high quality, high precision and high efficiency of the processing of the flexible double-sided electrodes. Moreover, by synchronously constructing electrodes on the upper and lower surfaces of the flexible electrode substrate, the integration and processing efficiency of the flexible double-sided electrodes and the micro energy storage devices having flexible double-sided electrodes are effectively enhanced, and the energy density of electrode output per unit area of the flexible double-sided electrodes and the micro energy storage devices having flexible double-sided electrodes is improved. By processing the flexible electrode substrate through an ultrafast laser micro-etching (ablation) process, the interdigital gap of electrodes may be reduced to 10 micrometers and below, in order to effectively enhance the specific capacity of the electrodes, and then improve the energy density of the electrode material. Moreover, micro-electrode arrays of different series and parallel forms may be easily prepared on the flexible electrode substrate to achieve arbitrary adjustable output voltage and capacity.

### BRIEF DESCRIPTION OF THE DRAWINGS

FIG. 1 is a flow diagram of an ultrafast laser processing method for flexible double-sided electrodes according to an embodiment of the present disclosure.

FIG. 2 is a flow diagram of step 100 according to an embodiment of the present disclosure.

FIG. 3 is a flow diagram of step 200 according to an embodiment of the present disclosure.

FIG. 4 is a structural block diagram of an ultrafast laser processing device according to an embodiment of the present disclosure.

FIG. 5 is a schematic structural diagram of an ultrafast laser processing device according to an embodiment of the present disclosure.

FIG. 6 is a schematic structural diagram of processing a flexible electrode substrate by means of an ultrafast laser according to an embodiment of the present disclosure.

### DESCRIPTION OF REFERENCE NUMERALS

1—Flexible electrode substrate; 2—Ultrafast laser processing device, 21—Ultrafast laser unit, 22—Laser transmission shaping mechanism, 221—Optical shutter, 222—Beam expander, 223—Half-wave plate, 224—Reflector group, 225—Visible light transmission laser reflector, 226—Focusing objective lens, 23—Focusing and observing mechanism, 231—White light source, 232—Observing mirror group, 232a—Attenuator, 232b—Optical filter, 232c—CCD image sensor, 232d—Optical lens, 232e—Non-polarized white light beam splitter, 24—Working table, 25—Air supply mechanism, and 26—Power supply.

### DETAILED DESCRIPTION OF THE INVENTION

In order to make the above objectives, features and advantages of the present disclosure more clearly understood, specific embodiments of the present disclosure are described in detail below with reference to the accompanying drawings.

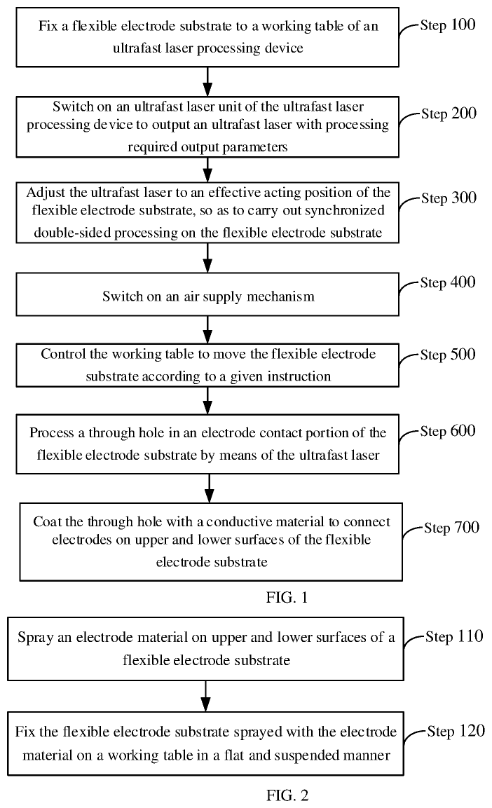

As shown in FIG. 1, and FIG. 4 to FIG. 6, an embodiment of the present disclosure provides an ultrafast laser processing method for flexible double-sided electrodes. The method specifically includes the following steps:

Step 100: Fix a flexible electrode substrate 1 to a working table 24 of an ultrafast laser processing device 2.

Step 200: Switch on an ultrafast laser unit 21 of the ultrafast laser processing device 2 to output an ultrafast laser with processing required output parameters.

Step 300: Adjust the ultrafast laser to an effective acting position of the flexible electrode substrate 1, so as to carry out synchronized double-sided processing on the flexible electrode substrate 1.

In this embodiment, the ultrafast laser processing method for flexible double-sided electrodes is implemented using the ultrafast laser processing device 2 to process flexible double-sided electrodes on the flexible electrode substrate 1 (e.g., a flexible film). Specifically, the flexible electrode substrate 1 with upper and lower surfaces sprayed with an electrode material is firstly fixed on the working table 24 of the ultrafast laser processing device 2 by step 100 to ensure stability of the flexible electrode substrate 1 during processing. Then, by step 200, the ultrafast laser unit 21 (which serves as an ultrafast laser beam output source for generating the ultrafast laser) of the ultrafast laser processing device 2 outputs the ultrafast laser with suitable processing required output parameters to effectively process the flexible electrode substrate 1. The energy density of the ultrafast laser outputted by the ultrafast laser unit 21 with the processing required output parameters reaches an ablation threshold of the electrode material (described hereinafter) sprayed on the flexible electrode substrate 1, and is lower than an ablation threshold of the flexible electrode substrate 1, thereby preventing the flexible electrode substrate 1 from being ablated by the ultrafast laser. Afterwards, by step 300, the position of a laser transmission shaping mechanism 22 (described hereinafter) of the ultrafast laser processing device 2 or the flexible electrode substrate 1 is adjusted so as to adjust the ultrafast laser to the effective acting position on the flexible electrode substrate 1, which ensures that the upper and lower surfaces of the flexible electrode substrate 1 are within the effective acting range of the ultrafast laser, so that the ultrafast laser acting on the effective acting position of the flexible electrode substrate 1 may carry out synchronized double-sided processing on the flexible electrode substrate 1, thereby obtaining flexible double-sided electrodes.

In this way, the method carries out synchronized double-sided processing on the flexible electrode substrate 1 by means of the ultrafast laser to synchronously construct electrodes on the upper and lower surfaces of the flexible electrode substrate 1, thereby obtaining flexible double-sided electrodes to be used for the preparation of micro energy storage devices (for example, micro-supercapacitors), and the like, having the advantages of high quality, high precision, high efficiency, etc. of laser processing, and achieving high quality, high precision and high efficiency of the processing of the flexible double-sided electrodes. Moreover, by synchronously constructing electrodes on the upper and lower surfaces of the flexible electrode substrate 1, the integration and processing efficiency of the flexible double-sided electrodes and the micro energy storage devices having flexible double-sided electrodes are effectively enhanced, and the energy density of electrode output per unit area of the flexible double-sided electrodes and the micro energy storage devices having flexible double-sided electrodes is improved. By processing the flexible electrode substrate 1 through an ultrafast laser micro-etching (ablation) process, the interdigital gap of electrodes may be reduced to 10 micrometers and below, in order to effectively enhance the specific capacity of the electrodes, and then improve the energy density of the electrode material. Moreover, micro-electrode arrays of different series and parallel forms may be easily prepared on the flexible electrode substrate 1 to achieve arbitrary adjustable output voltage and capacity.

Optionally, the flexible electrode substrate 1 is made of a transparent material, a translucent material, and other materials that easily achieve double-sided laser processing.

Optionally, as shown in FIG. 1 and FIG. 2, step 100 specifically includes the following steps:

Step 110: Spray the electrode material on the upper and lower surfaces of the flexible electrode substrate 1.

Specifically, the flexible electrode substrate 1, as a carrier of the electrode material, may improve the stability of the electrode material as well as facilitate ultrafast laser processing of the electrode material. The upper and lower surfaces of the flexible electrode substrate 1 are sprayed with the electrode material to process the flexible double-sided electrode by subsequent steps.

Step 120: Fix the flexible electrode substrate 1 sprayed with the electrode material on the working table 24 in a flat and suspended manner.

Specifically, the flexible electrode substrate 1 sprayed with the electrode material is flatly fixed to the working table 24 to ensure that the ultrafast laser may reach each processing position on the flexible electrode substrate 1, thereby ensuring the smooth progress of the ultrafast laser processing. Moreover, the portion of the flexible electrode substrate 1 other than the fixed position (used to be fixed to the working table 24 by means of a fixing fixture) is suspended, so as to avoid the occurrence of the situation that while a through hole and other structures are processed on the flexible electrode substrate 1, a molten material is deposited between the working table 24 and the flexible electrode substrate 1 and fails to form the desired through hole. Therefore, due to suspension of the flexible electrode substrate 1, smooth processing of the flexible double-sided electrodes is ensured, and high-quality and high-efficient processing of the flexible double-sided electrodes is achieved.

Optionally, as shown in FIG. 6, an absolute value of a difference between a thickness of the flexible electrode substrate 1 and twice a Rayleigh length of the ultrafast laser on a focusing region of the flexible electrode substrate 1 is less than a first threshold. The adjusting the ultrafast laser to an effective acting position of the flexible electrode substrate 1 includes:
adjusting a focal position of the ultrafast laser to a center position between upper and lower surfaces of the flexible electrode substrate 1.

The principle of the ultrafast laser processing method for flexible double-sided electrodes to achieve synchronized double-sided processing of the flexible electrode substrate 1 is that when the energy density of the laser reaches the ablation threshold of the material, the material may be transformed into a plasma and then ablated away. A focused ultrafast laser beam has a Rayleigh length (Rayleigh range) in the focal region, and effective processing may be achieved within the Rayleigh length. The Rayleigh length of the ultrafast laser beam refers to the distance from the beam waist (i.e., the waist of the ultrafast laser beam, which is located in the focal region of the ultrafast laser beam) to the cross-section with an area being twice the area of the waist of the ultrafast laser beam along the direction of travel thereof. In this way, by adjusting the focal position of the ultrafast laser beam to the center position between the upper and lower surfaces of the flexible electrode substrate 1, the vertical distances from the focal point of the ultrafast laser beam to both the upper and lower surfaces of the flexible electrode substrate 1 are close to the Rayleigh length, i.e., the absolute value of the difference between the thickness of the flexible electrode substrate 1 and twice the Rayleigh length of the ultrafast laser in the focusing region of the flexible electrode substrate 1 is less than the first threshold, thereby achieving synchronized ultrafast laser etching processing for the electrode material sprayed on the upper and lower surfaces of the flexible electrode substrate 1. The first threshold may be set according to corresponding parameters of the flexible electrode substrate 1 and the ultrafast laser, with the purpose of ensuring that the vertical distances from the focal point of the ultrafast laser located at the center position between the upper and lower surfaces of the flexible electrode substrate 1 to the upper and lower surfaces of the flexible electrode substrate 1 are both close to the Rayleigh length, so as to achieve effective processing.

Optionally, as shown in FIG. 1, after step 300, the ultrafast laser processing method for flexible double-sided electrodes further includes the following steps:

Step 600: Process a through hole in an electrode contact portion of the flexible electrode substrate 1 by means of the ultrafast laser.

Step 700: Coat the through hole with a conductive material to connect electrodes on the upper and lower surfaces of the flexible electrode substrate 1.

Specifically, by steps 600 and 700, the through hole penetrating through the upper and lower surfaces of the flexible electrode substrate 1 is processed at the corresponding electrode contact portion on the flexible electrode substrate 1, and the through hole is coated (filled) with the conductive material (e.g., conductive silver paste) to achieve an electrical connection of the corresponding electrodes on the upper and lower surfaces of the flexible electrode substrate 1, thus completing the ultrafast laser processing of the flexible double-sided electrodes.

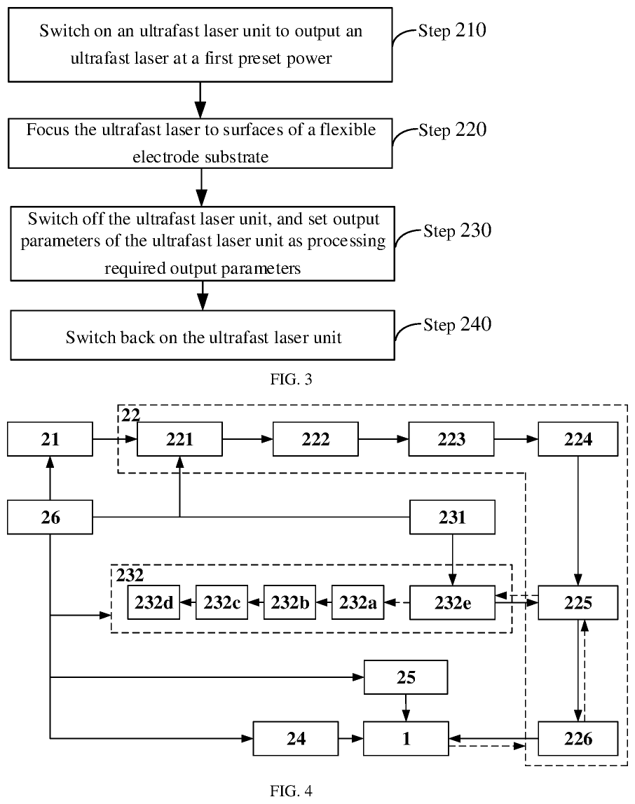

Optionally, as shown in FIG. 1 and FIG. 3, step 200 specifically includes the following steps:

Step 210: Switch on the ultrafast laser unit 21 to output the ultrafast laser at a first preset power.

Specifically, the ultrafast laser unit 21 is switched on to output the ultrafast laser at the first preset power. The ultrafast laser of the first preset power is a low-power ultrafast laser with an energy density that is much lower than the ablation threshold of the corresponding electrode material, so as to avoid ablating the material before the ultrafast laser is adjusted to the appropriate processing position.

Step 220: Focus the ultrafast laser to the surfaces of the flexible electrode substrate 1.

Specifically, by adjusting the position of each lens (described hereinafter) of the laser transmission shaping mechanism 22 of the ultrafast laser processing device 2, a light path of the ultrafast laser is adjusted to be suitable, and the ultrafast laser is focused onto the surfaces of the flexible electrode substrate 1, so as to facilitate adjustment of the ultrafast laser to focus onto the center position between the upper and lower surfaces of the flexible electrode substrate 1 in the subsequent step.

Step 230: Switch off the ultrafast laser unit 21, and set output parameters of the ultrafast laser unit 21 as the processing required output parameters.

Step 240: Switch back on the ultrafast laser unit 21.

Specifically, after the ultrafast laser unit 21 is switched off, an optical shutter 221 (described hereinafter) is closed, and the output parameters of the ultrafast laser unit 21 are set to be the processing required output parameters. The processing required output parameters are laser output parameters that cause the energy density of the ultrafast laser outputted by the ultrafast laser unit 21 to reach the ablation threshold of the electrode material sprayed on the flexible electrode substrate 1 and to be lower than the ablation threshold of the flexible electrode substrate 1. Afterwards, the ultrafast laser unit 21 is switched back on, the optical shutter 221 is opened, and the ultrafast laser unit 21 outputs the ultrafast laser with the processing requirement output parameters.

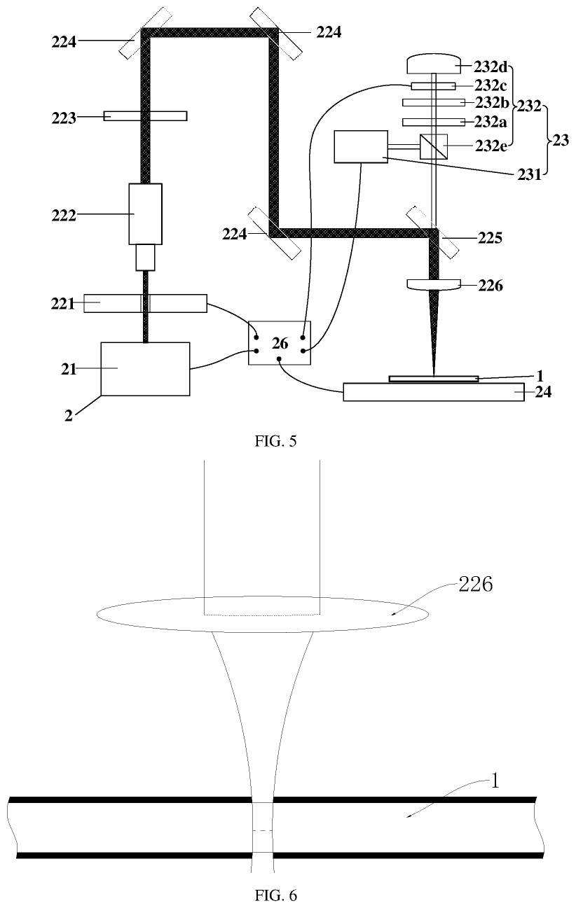

Optionally, as shown in FIG. 4 and FIG. 5, the ultrafast laser processing device 2 further includes the laser transmission shaping mechanism 22, and the laser transmission shaping mechanism 22 includes the optical shutter 221, a beam expander 222, a half-wave plate 223, a reflector group 224, and a focusing objective lens 226. The ultrafast laser outputted by the ultrafast laser unit 21 acts on the flexible electrode substrate 1 after passing through the optical shutter 221, the beam expander 222, the half-wave plate 223, the reflector group 224, and the focusing objective lens 226 in sequence.

The laser transmission shaping mechanism 22 of the ultrafast laser processing device 2 is used for adjusting and guiding the ultrafast laser emitted by the ultrafast laser unit 21 to the flexible electrode substrate 1. The optical shutter 221 is used for passing or blocking ultrafast laser pulses emitted by the ultrafast laser unit 21, and controlling the number of pulses output (i.e., controlling the number of ultrafast laser pulses passing through the optical shutter 221). The beam expander 222 is used for expanding ultrafast pulse beams emitted by the ultrafast laser unit 21, so as to facilitate the subsequent adjustment and focusing of the ultrafast pulse beams by a light path to obtain smaller spots. The half-wave plate 223 is used for adjusting a polarization state of the ultrafast laser beams, for example, adjusting the polarization state of the ultrafast laser from linear polarization to circular polarization or elliptical polarization. The reflector group 224 includes a plurality of reflectors for reflecting the ultrafast laser. The focusing objective lens 226 is used for focusing the ultrafast laser onto the flexible electrode substrate 1 on the working table 24.

In some embodiments, the ultrafast laser unit 21, the optical shutter 221, the beam expander 222, and the half-wave plate 223 are coaxially mounted in sequence. The reflector group 224 is provided with a plurality of reflectors to change the direction of the ultrafast laser, thus enabling more possibilities for the structural design of the ultrafast laser processing device 2.

Optionally, as shown in FIG. 4 and FIG. 5, the ultrafast laser processing device 2 further includes a focusing and observing mechanism 23, and the focusing and observing mechanism 23 includes a white light source 231 and an observing mirror group 232. The white light source 231 is used for emitting a white light that is coaxially incident onto the surfaces of the flexible electrode substrate 1 with the ultrafast laser. The observing mirror group 232 is used for receiving part of the white light reflected by the flexible electrode substrate 1.

In this embodiment, the focusing and observing mechanism 23 includes the white light source 231 and the observing mirror group 232, where the observing mirror group 232 includes an attenuator 232a, an optical filter 232b, a CCD image sensor 232c, and an optical lens 232d. The attenuator 232a and the optical filter 232b are used for converting the white light entering the observing mirror group 232 (the attenuator 232a and the optical filter 232b) into optical signals that may be accepted and processed by the CCD image sensor 232c. The CCD image sensor 232c converts the corresponding optical signals into digital image signals and displays same through the optical lens 232d, so as to observe whether the ultrafast laser is focused on the surfaces of the flexible electrode substrate 1. The laser transmission shaping mechanism 22 further includes a visible light transmission laser reflector 225 (for reflecting the laser beams and transmitting the white light) disposed between the reflector group 224 and the focusing objective lens 226. The ultrafast laser outputted by the ultrafast laser unit 21 acts on the flexible electrode substrate 1 after passing through the optical shutter 221, the beam expander 222, the half-wave plate 223, the reflector group 224, the visible light transmission laser reflector 225 and the focusing objective lens 226 in sequence. The reflector group 224 is used for reflecting the ultrafast laser to the visible light transmission laser reflector 225; the visible light transmission laser reflector 225 reflects the ultrafast laser reflected from the reflector group 224 towards the focusing objective lens 226; and the ultrafast laser is vertically incident to the focusing objective lens 226 after being reflected by the visible light transmission laser reflector 225, is focused by the focusing objective lens 226 and then arrives at the flexible electrode substrate 1 on the working table 24.

The observing mirror group 232 and the focusing objective lens 226 are located on both sides of the visible light transmission laser reflector 225 respectively. The observing mirror group 232 further includes a non-polarized white light beam splitter 232e, and the non-polarized white light beam splitter 232e is used for separating the energy of the incident light and obtaining reflected and refracted light of a lower intensity, so as to facilitate observation. The non-polarized white light beam splitter 232e, the attenuator 232a, the optical filter 232b, the CCD image sensor 232c, and the optical lens 232d are provided in sequence in the direction from the focusing objective lens 226 to the visible light transmission laser reflector 225. In step 220, by adjusting the position of each lens of the laser transmission shaping mechanism 22 of the ultrafast laser processing device 2, the spot of the ultrafast laser is located at the center of each lens and is vertically incident to the focusing objective lens 226, and at the same time, by observing with the aid of the white light source 231 and the observing mirror group 232, it is ensured that the ultrafast laser is focused onto the surfaces of the flexible electrode substrate 1. The observation with the aid of the white light source 231 and the observing mirror group 232 is: the white light emitted by the white light source 231 is directed to and illuminates the surface of the flexible electrode substrate 1 after being coaxially incident on the focusing objective lens 226 with the ultrafast laser reflected by the visible light transmission laser reflector 225 by means of the non-polarized white light beam splitter 232e and the visible light transmission laser reflector 225, part of the white light is reflected by the surface of the flexible electrode substrate 1, and the reflected white light passes through the focusing objective lens 226, the visible light transmission laser reflector 225, and the non-polarized white light beam splitter 232e in sequence to enter the attenuator 232a, the optical filter 232b, the CCD image sensor 232c, and the optical lens 232d of the observing mirror group 232. Thus, whether the ultrafast laser is focused onto the surfaces of the flexible electrode substrate 1 is observed by means of the white light source 231 and the observing mirror group 232.

Optionally, the working table 24 includes a processing table and a fixing fixture disposed on the processing table and adapted to fixing the flexible electrode substrate 1, and at least one of the processing table and the fixing fixture is adapted to moving relative to the focusing objective lens 226.

The working table 24 (for example, a micro/nano working table) fixes the flexible electrode substrate 1 sprayed with the electrode material on the processing table in a flat and suspended manner by means of the fixing fixture, so as to facilitate laser processing of the flexible electrode substrate 1 sprayed with the electrode material. The processing table may be moved relative to the focusing objective lens 226, and/or the fixing fixture may be moved relative to the focusing objective lens 226, so as to facilitate the movement of the flexible electrode substrate 1 to a processing position through the working table 24. For example, upon the completion of etching of the electrode material in a region on the flexible electrode substrate 1, the flexible electrode substrate 1 is moved through the working table 24, so that the ultrafast laser is relatively moved to another region on the flexible electrode substrate 1 for processing.

In step 300, the focal position of the ultrafast laser is adjusted to the center position between the upper and lower surfaces of the flexible electrode substrate 1, by rotating the half-wave plate 223 to adjust the polarization state of the ultrafast laser and moving the laser focus to the center position between the upper and lower surfaces of the flexible electrode substrate 1; and/or, by moving the flexible electrode substrate 1 through the working table 24 until the laser focus is located at the center position between upper and lower surfaces of the flexible electrode substrate 1.

Optionally, as shown in FIG. 4, the ultrafast laser processing device 2 further includes a gas supply mechanism 25, the air supply mechanism 25 having a nozzle disposed towards the fixing fixture. After step 300 and prior to step 600, the ultrafast laser processing method for flexible double-sided electrodes further includes the following steps:

Step 400: Switch on the air supply mechanism 25.

Specifically, the air supply mechanism 25 ejects an airflow through the nozzle to the flexible electrode substrate 1 disposed on the working table 24, so as to facilitate timely removal of the etched material on the flexible electrode substrate 1, and to ensure the smooth progress of the ultrafast laser processing.

Optionally, as shown in FIG. 1, after step 400 and prior to step 600, the ultrafast laser processing method for flexible double-sided electrodes further includes the following steps:

Step 500: Control the working table 24 to move the flexible electrode substrate 1 according to a given instruction.

Specifically, the working table 24 moves the flexible electrode substrate 1 in a certain trajectory according to the given instruction (set instruction) to achieve relative motion between the ultrafast laser and the flexible electrode substrate 1, so as to process flexible double-sided electrodes having the desired structure. Upon the completion of etching of the electrode material region, the flexible electrode substrate 1 is moved through the working table 24 until the ultrafast laser is located in a non-electrode region on the flexible electrode substrate 1 to etch the non-electrode region (e.g., processing a through hole in the subsequent step).

Optionally, as shown in FIG. 4 and FIG. 5, the ultrafast laser processing device 2 further includes a power supply 26, and the power supply 26 is used for supplying power to components of the ultrafast laser processing device 2 that need to be powered (for example, the ultrafast laser unit 21, the optical shutter 221, the white light source 231, the working table 24, and the CCD image sensor 232c). In some embodiments, the ultrafast laser processing method for flexible double-sided electrodes requires switching on the power supply 26, the optical shutter 221, the white light source 231, and the observing mirror group 232 before step 100.

Although the present disclosure is disclosed as above, the scope of protection of the present disclosure is not limited thereto. Various changes and modifications may be made by those skilled in the art without departing from the spirit and scope of the present disclosure, and these changes and modifications will fall within the scope of protection of the present disclosure.

1. An ultrafast laser processing method for flexible double-sided electrodes, comprising:
fixing a flexible electrode substrate (1) to a working table (24) of an ultrafast laser processing device (2);
switching on an ultrafast laser unit (21) of the ultrafast laser processing device (2) to output an ultrafast laser with processing required output parameters; and
adjusting the ultrafast laser to an effective acting position of the flexible electrode substrate (1), so as to carry out synchronized double-sided processing on the flexible electrode substrate (1).

2. The ultrafast laser processing method for flexible double-sided electrodes according to claim 1, wherein an absolute value of a difference between a thickness of the flexible electrode substrate (1) and twice a Rayleigh length of the ultrafast laser on a focusing region of the flexible electrode substrate (1) is less than a first threshold; and the adjusting the ultrafast laser to an effective acting position of the flexible electrode substrate (1) comprises:
adjusting a focal position of the ultrafast laser to a center position between upper and lower surfaces of the flexible electrode substrate (1).

3. The ultrafast laser processing method for flexible double-sided electrodes according to claim 1, wherein the fixing a flexible electrode substrate (1) to a working table (24) of an ultrafast laser processing device (2) comprises:
spraying an electrode material on the upper and lower surfaces of the flexible electrode substrate (1); and
fixing the flexible electrode substrate (1) sprayed with the electrode material on the working table (24) in a flat and suspended manner.

4. The ultrafast laser processing method for flexible double-sided electrodes according to claim 1, wherein after the adjusting the ultrafast laser to an effective acting position of the flexible electrode substrate (1), so as to carry out synchronized double-sided processing on the flexible electrode substrate (1), the ultrafast laser processing method for flexible double-sided electrodes further comprises:
processing a through hole in an electrode contact portion of the flexible electrode substrate (1) by means of the ultrafast laser; and
coating the through hole with a conductive material to connect electrodes on the upper and lower surfaces of the flexible electrode substrate (1).

5. The ultrafast laser processing method for flexible double-sided electrodes according to claim 1, wherein the switching on an ultrafast laser unit (21) of the ultrafast laser processing device (2) to output an ultrafast laser with processing required output parameters comprises:
switching on the ultrafast laser unit (21) to output the ultrafast laser at a first preset power;
focusing the ultrafast laser to the surfaces of the flexible electrode substrate (1);
switching off the ultrafast laser unit (21), and setting output parameters of the ultrafast laser unit (21) as the processing required output parameters; and
switching back on the ultrafast laser unit (21).

6. The ultrafast laser processing method for flexible double-sided electrodes according to claim 1, wherein the ultrafast laser processing device (2) further comprises a laser transmission shaping mechanism (22), the laser transmission shaping mechanism (22) comprising an optical shutter (221), a beam expander (222), a half-wave plate (223), a reflector group (224), and a focusing objective lens (226); and the ultrafast laser outputted by the ultrafast laser unit (21) acts on the flexible electrode substrate (1) after passing through the optical shutter (221), the beam expander (222), the half-wave plate (223), the reflector group (224), and the focusing objective lens (226) in sequence.

7. The ultrafast laser processing method for flexible double-sided electrodes according to claim 1, wherein the ultrafast laser processing device (2) further comprises a focusing and observing mechanism (23), the focusing and observing mechanism (23) comprises a white light source (231) and an observing mirror group (232), the white light source (231) is used for emitting a white light that is coaxially incident onto the surfaces of the flexible electrode substrate (1) with the ultrafast laser, and the observing mirror group (232) is used for receiving part of the white light reflected by the flexible electrode substrate (1).

8. The ultrafast laser processing method for flexible double-sided electrodes according to claim 3, wherein the working table (24) comprises a processing table and a fixing fixture disposed on the processing table and adapted to fixing the flexible electrode substrate (1), and at least one of the processing table and the fixing fixture is adapted to moving relative to the focusing objective lens (226).

9. The ultrafast laser processing method for flexible double-sided electrodes according to claim 8, wherein the ultrafast laser processing device (2) further comprises an air supply mechanism (25), the air supply mechanism (25) having a nozzle disposed towards the fixing fixture; and after the adjusting the ultrafast laser to an effective acting position of the flexible electrode substrate (1), so as to carry out synchronized double-sided processing on the flexible electrode substrate (1), and prior to processing through hole in an electrode contact portion of the flexible electrode substrate (1) by means of the ultrafast laser, the ultrafast laser processing method for flexible double-sided electrodes further comprises:
switching on the air supply mechanism (25).

10. The ultrafast laser processing method for flexible double-sided electrodes according to claim 9, wherein after the switching on the air supply mechanism (25), and prior to processing through holes in an electrode contact portion of the flexible electrode substrate (1) by means of the ultrafast laser, the ultrafast laser processing method for flexible double-sided electrodes further comprises:
controlling the working table (24) to move the flexible electrode substrate (1) according to a given instruction.

11. The ultrafast laser processing method for flexible double-sided electrodes according to claim 2, wherein the fixing a flexible electrode substrate (1) to a working table (24) of an ultrafast laser processing device (2) comprises:
spraying an electrode material on the upper and lower surfaces of the flexible electrode substrate (1); and
fixing the flexible electrode substrate (1) sprayed with the electrode material on the working table (24) in a flat and suspended manner.

12. The ultrafast laser processing method for flexible double-sided electrodes according to claim 2, wherein after the adjusting the ultrafast laser to an effective acting position of the flexible electrode substrate (1), so as to carry out synchronized double-sided processing on the flexible electrode substrate (1), the ultrafast laser processing method for flexible double-sided electrodes further comprises:
processing a through hole in an electrode contact portion of the flexible electrode substrate (1) by means of the ultrafast laser; and
coating the through hole with a conductive material to connect electrodes on the upper and lower surfaces of the flexible electrode substrate (1).

13. The ultrafast laser processing method for flexible double-sided electrodes according to claim 2, wherein the switching on an ultrafast laser unit (21) of the ultrafast laser processing device (2) to output an ultrafast laser with processing required output parameters comprises:
switching on the ultrafast laser unit (21) to output the ultrafast laser at a first preset power;
focusing the ultrafast laser to the surfaces of the flexible electrode substrate (1);
switching off the ultrafast laser unit (21), and setting output parameters of the ultrafast laser unit (21) as the processing required output parameters; and
switching back on the ultrafast laser unit (21).

14. The ultrafast laser processing method for flexible double-sided electrodes according to claim 2, wherein the ultrafast laser processing device (2) further comprises a laser transmission shaping mechanism (22), the laser transmission shaping mechanism (22) comprising an optical shutter (221), a beam expander (222), a half-wave plate (223), a reflector group (224), and a focusing objective lens (226); and the ultrafast laser outputted by the ultrafast laser unit (21) acts on the flexible electrode substrate (1) after passing through the optical shutter (221), the beam expander (222), the half-wave plate (223), the reflector group (224), and the focusing objective lens (226) in sequence.

15. The ultrafast laser processing method for flexible double-sided electrodes according to claim 2, wherein the ultrafast laser processing device (2) further comprises a focusing and observing mechanism (23), the focusing and observing mechanism (23) comprises a white light source (231) and an observing mirror group (232), the white light source (231) is used for emitting a white light that is coaxially incident onto the surfaces of the flexible electrode substrate (1) with the ultrafast laser, and the observing mirror group (232) is used for receiving part of the white light reflected by the flexible electrode substrate (1).
